(19) United States
(12) Patent Application Publication
(10) Pub. No.: US 2009/0067623 A1
(43) Pub. Date: Mar. 12, 2009

(54) Method and apparatus for performing fast authentication for vertical handover

(75) Inventors: Peng Lei, Suwon-si (KR); Jeong-Jae Won, Hwaseong-si (KR); Young-Seok Kim, Seongnam-si (KR); Kyu-Tae Choi, Suwon-si (KR); Eui-Seok Hwang, Hwaseong-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/283,405

(22) Filed: Sep. 11, 2008

(30) Foreign Application Priority Data
Sep. 12, 2007 (KR) 2007-0092409

(51) Int. Cl. H04L 9/06

(52) U.S. Cl. 380/44

(57) ABSTRACT

A method and apparatus for performing fast authentication for a vertical handover are provided. The method includes requesting a handover from a serving network to a target network and generating a derivative Master Session Key (MSK) for key generation, and transmitting the derivative MSK to the target network. Accordingly, a key negotiation process can start by skipping an access authentication process. Therefore, there is an advantage in that a fast authentication process can be achieved.

### CROSS-REFERENCE TO RELATED APPLICATION(S) AND CLAIM OF PRIORITY

The present application claims the benefit under 35 U.S.C. § 119(a) of a Korean patent application filed in the Korean Intellectual Property Office on Sep. 12, 2007 and assigned Serial No. 2007-92409, the entire disclosure of which is hereby incorporated by reference.

### TECHNICAL FIELD OF THE INVENTION

The present invention relates to a fast authentication. More particularly, the present invention relates to a method and apparatus for performing fast authentication when a Media Independent Handover (MIH)-based vertical handover is performed between heterogeneous networks.

### BACKGROUND OF THE INVENTION

With the development of wireless communications, a 3rd Generation (3G) cellular network, an Institute of Electrical and Electronics Engineers (IEEE) 802.11 Wireless Local Area Network (WLAN) network, a Broadband Wireless Access (BWA) network, and other types of networks co-exist in the current network environment. To provide improved performance, in the co-existing different networks, a special PHYsical (PHY) layer and a Media Access Control (MAC) layer are separated from each other. A handover technique is required for a handover between heterogeneous networks using difference access technologies. Therefore, a Media Independent Handover (MIH) technique is standardized by the IEEE 802.21 group to provide seamless communications between the heterogeneous networks.

A full authentication process of a mobile station (MS) needs to be considered together with a vertical handover technique. An Extensible Authentication Protocol (EAP) has a general authentication structure widely used in a wireless network. The EAP is not a special authentication mechanism. The EAP provides several common functions and negotiation of a desired authentication mechanism. Due to excellent extensibility and flexibility, most of wireless authentication protocols use an EAP-based WLAN IEEE 802.11n standard or a BWA Privacy Key Management version 2 (PKMv2).

The full authentication process can be classified into two processes (i.e., access authentication and key authentication). During the access authentication, a MS is authenticated by an access network according to an authentication method such as EAP-Transport Layer Security (EAP-TLS), EAP-Tunneled TLS (EAP-TTLS), EAP-Authentication and Key Agreement (EAP-AKA), and a Protected Extensible Authentication Protocol (PEAP). When the access authentication is performed, a Master Session Key (MSK) having a length of 512 bits is generated in both sides of the MS and an authentication server. The authentication server distributes the MSK to an authenticator. After the access authentication is completed, the MS and the authenticator have the same MSK, and use the MSK as a root key for a key negotiation process.

During the key negotiation process, a handshake message is exchanged between the MS and the authenticator. The handshake message may be either a 4-way handshake message for the WLAN network or a 3-way handshake message for the BWA network. By using the handshake message, encryption keys can be finally synchronized with a Security Association (SA). The key negotiation is performed between the MS and the authenticator without the aid of the authentication server. When the full authentication process is performed, the access authentication process requires more time than the key negotiation process. In other words, a time required for performing the full authentication process is mostly consumed to perform the access authentication process.

As described above, the IEEE 802.21 standard provides the MIH technique to support the vertical handover. However, although authentication is absolutely necessary before network access, there is no authentication-related scenario. At present, an optimal authentication scheme discussed in the standard performs full authentication while a handover occurs between heterogeneous networks. The full authentication may spend hundreds of milli-seconds or several seconds due to a communication delay of a core network and a processing delay of an authentication server. Such delays are not allowed in real-time applications. For example, a bidirectional application service may be terminated in the handover process due to a delay caused by recovery, registration, authentication, mobile bounding update, and so forth. Examples of the bidirectional application service are streaming media service and a Voice over Internet Protocol (VoIP) service, which are sensitive to an end-to-end delay and a packet loss.

### SUMMARY OF THE INVENTION

To address the above-discussed deficiencies of the prior art, it is a primary aspect of the present invention to solve at least the above-mentioned problems and/or disadvantages and to provide at least the advantages described below. Accordingly, an aspect of the present invention is to provide a method and apparatus for performing fast authentication for a vertical handover.

Another aspect of the present invention is to provide a method and apparatus for performing a key negotiation process by skipping an access authentication process while performing a full authentication process by using a Master Session Key (MSK) derived between authenticators during a vertical handover.

In accordance with an aspect of the present invention, a method of performing fast authentication for a vertical handover is provided. The method includes requesting a handover from a serving network to a target network and generating a derivative MSK for key generation, and transmitting the derivative MSK to the target network.

In accordance with another aspect of the present invention, a mobile communication system performing fast authentication for a vertical handover is provided. The system includes a serving mobile station (MS) for requesting a handover from a serving network to a target network, and a serving authenticator for generating a derivative MSK for key generation in the serving network and for transmitting the generated MSK to the target network.

In accordance with another aspect of the present invention, a method of operating a MS performing fast authentication for a vertical handover is provided. The method includes, after requesting a handover to a target network, receiving information used to generate a first derivative MSK for key generation, generating the derivative MSK, and performing key negotiation with the target network by using the derivative MSK.

In accordance with another aspect of the present invention, a method of operating a target authenticator performing fast authentication for a vertical handover is provided. The method includes receiving a first derivative MSK for key generation from a serving network, and performing key negotiation by using the derivative MSK.

In accordance with another aspect of the present invention, a method of operating a serving authenticator performing fast authentication for a vertical handover is provided. The method includes, after receiving a handover request from a MS, generating a derivative MSK, and transmitting the derivative MSK to a target network.

In accordance with another aspect of the present invention, a MS apparatus performing fast authentication for a vertical handover is provided. The apparatus includes a controller for receiving information used to generate a first derivative MSK for key generation after requesting a handover to a target network, a key generator for generating the derivative MSK, and an authentication processor for performing key negotiation with the target network by using the derivative MSK.

In accordance with another aspect of the present invention, a target authentication apparatus performing fast authentication for a vertical handover is provided. The apparatus includes a controller for receiving a first derivative MSK for key generation from a serving network, and an authentication manager for performing key negotiation by using the derivative MSK.

In accordance with another aspect of the present invention, a serving authentication apparatus performing fast authentication for a vertical handover is provided. The apparatus includes a handover processor for receiving a handover request from a MS, a key generator for generating a derivative MSK after the handover request, and an authentication processor for transmitting the derivative MSK to a network.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior uses, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a flow diagram of full authentication process in a Wireless Local Area Network (WLAN) network according to an embodiment of the present invention;

FIG. 2 a flow diagram of a full authentication process in a Broadband Wireless Access (BWA) network according to an embodiment of the present invention;

FIGS. 3A to 3C illustrate a flow diagram illustrating an authentication process during a vertical handover according to a first embodiment of the present invention;

FIGS. 4A to 4C illustrate a flow diagram illustrating an authentication process during a vertical handover according to a second embodiment of the present invention;

FIG. 5 is a flowchart illustrating an operation of a mobile station (MS) for performing fast authentication during a vertical handover according to an embodiment of the present invention;

FIG. 6 is a flowchart illustrating an operation of a target authenticator for performing authentication during a vertical handover according to an embodiment of the present invention;

FIG. 7 is a flowchart illustrating an operation of a serving authenticator for performing authentication during a vertical handover according to an embodiment of the present invention;

FIG. 8 is a block diagram illustrating a MS apparatus for performing fast authentication during a vertical handover according to an embodiment of the present invention; and

FIG. 9 is a block diagram illustrating a serving authentication apparatus for performing authentication for a vertical handover according to an exemplary embodiment of the present invention.

### DETAILED DESCRIPTION OF THE INVENTION

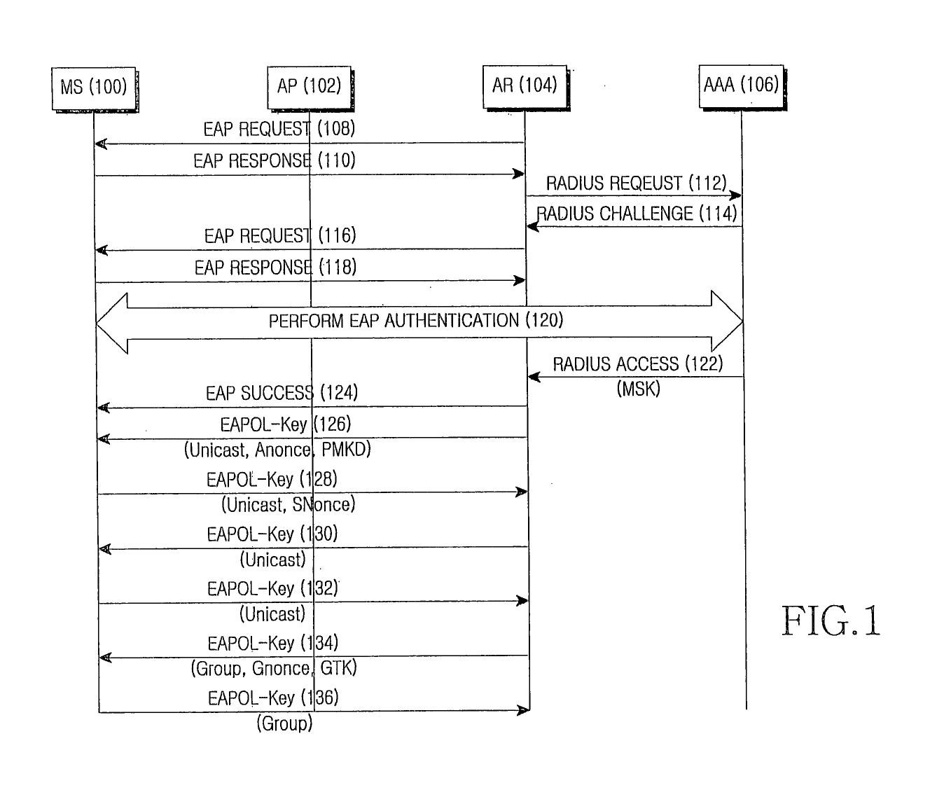

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present invention to be described hereinafter relates to a method and apparatus for fast authentication, whereby key negotiation is performed by skipping access authentication using a derivative Master Session Key (MSK) for a vertical handover. The vertical handover is a handover between heterogeneous networks that use different technologies.

FIG. 1 is a flow diagram of full authentication process in a Wireless Local Area Network (WLAN) network.

Referring to FIG. 1, when a mobile station (MS) 100 starts an authentication process, an Access Router (AR) 104 transmits an Extensible Authentication Protocol (EAP) Request/Identify message to the MS 100 in step 108. According to embodiments, instead of the AR 104, an Access Point (AP) 102 may transmit the EAP Request/Identify message. The AR 104 mediates authentication between the MS 100 and an Authentication, Authorization, and Accounting (AAA) server 106 and will hereinafter be referred to as an authenticator. The authenticator may be either the AP 102 or the AR 104.

In step 110, the MS 100 transmits an EAP Response/Identify message to the AR 104.

In step 112, the AR 104 encapsulates the EAP Response message including a user identity and thus transmits the encapsulated message (i.e., Radius Request) to the AAA server 106.

In step 114, the AAA server 106 transmits to the AR 104 a Radius Challenge message to request authentication (e.g., a password, and so forth) of the MS 100 whose identification is confirmed.

In step 116, the AR 104 relays the received Radius Challenge message to the MS 100 in the format of EAP Request/Authentication.

In step 118, the MS 100 transmits to the AR 104 an EAP Response message including a certificate.

In step 120, the MS 100 and the AAA server 106 perform EAP authentication. Examples of the EAP authentication include EAP-Transport Layer Security (EAP-TLS), EAP-Tunneled TLS (EAP-TTLS), EAP-Authentication and Key Agreement (EAP-AKA), a Protected Extensible Authentication Protocol (PEAP), and so forth. The EAP-TLS is representative authentication in which a user and an authentication server perform mutual authentication by using a certificate, generate a session-based dynamic Wired Equivalent Privacy (WEP) key, and distribute the generated key. The EAP-TTLS is an extended version of the EAP-TLS. In the EAP-TTLS, a password is used for MS authentication and a certificate is used for server authentication in order to address a problem in which a large-sized certificate is preserved and transmitted in a poor wireless environment. User information is reliably tunneled through the TLS protocol. Thus, anonymity of an external wiretapper is ensured throughout a wireless link up to an authentication server. The EAP-AKA is an authentication scheme in which an authentication and key matching mechanism proposed for International Mobile Telecommunications-2000 (IMT-2000) in the 3rd Generation Partnership Project (3GPP) is applied to the EAP. The PEAP provides a method for reliably transmitting authentication data such as legacy password-based protocol through a wireless network. The PEAP performs this method by using tunneling between a client and an authentication server. Like the TTLS that performs similar functions, by using only a server-side certificate, the PEAP authenticates a WLAN client by simplifying implantation and management of a security WLAN.

In step 122, the AAA server 106 determines whether the MS 100 performs normal access or abnormal access, and in case of the normal access, the AAA server 106 transmits a Radius Access message to the AR 104. The Radius Access message includes a Master Session Key (MSK). The MSK is used to derive other keys (e.g., Pairwise Master Key (PMK), Authentication Key (AK), and so forth) required for security.

In step 124, if a Radius Access/Accept message is received, the AR 104 transmits an EAP Success message to the MS 100. Otherwise, if a Radius Access/Reject message is received, the AR 104 transmits an EAP Failure message to the MS 100. Explanation on transmitting of the EAP Failure will be omitted since it is not important in the present invention.

Thereafter, a 4-way handshake is performed for key exchange between the MS 100 and the AR 104. That is, in step 126, the AR 104 transmits to the MS 100 an EAP Over LAN (EAPOL) Key message including Authenticator nonce (Anonce). A Pairwise Transient Key (PTK) can be generated when the MS 100 receives the EAPOL Key message. In step 128, the MS 100 transmits to the AR 104 an EAPOL Key message including Supplicant Nonce (Snonce). In this case, to ensure message integrity, the MS 100 transmits the EAPOL Key message by performing a Message Integrity code (MIC) operation on the EAPOL Key message by using PTK. In step 130, the AR 104 transmits to the MS 100 an EAPOL Key message to prove that the AR 104 has the same key as the MS 100. In step 132, the MS 100 transmits to the AR 104 an EAPOL Key message to complete the 4-way handshake.

Thereafter, a 2-way handshake is performed to generate a Group Transient Key (GTK) between the MS 100 and the AR 104. First, in step 134, the AR 104 transmits to the MS 100 an EAPOL Key message including Group nonce (Gnonce). Then in step 136, the MS 100 transmits to the AR 104 an EAPOL Key message to complete the 2-way handshake.

Thereafter, the authentication process of FIG. 1 ends.

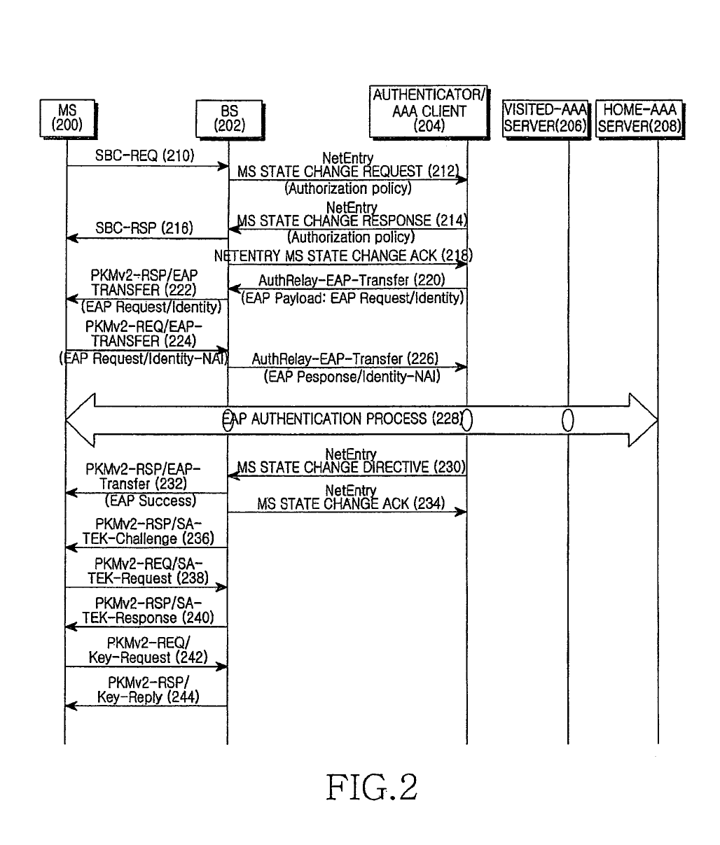

FIG. 2 is a flow diagram of a full authentication process in a Broadband Wireless Access (BWA) network.

Referring to FIG. 2, a MS 200 transmits a Subscriber Station Basic Capability REQuest (SBC-REQ) message to a BS 202 in step 210. The SBC-REQ message is used to negotiate an authentication policy and a message authentication code mode.

In step 212, upon receiving the SBC-REQ message from the MS 200, the BS 202 transmits a NetEntry MS State Change Request message to an AAA client 204 in order to report information on the MS 200 which attempts network entry.

In step 214, upon receiving the NetEntry MS State Change Request message, the AAA client 204 transmits a NetEntry MS State Change Response message to the BS 202.

In step 216, upon receiving the NetEntry MS State Change Response message, the BS 202 transmits a Subscriber Station Basic Capability ReSPonse (SBC-RSP) message to the MS 200.

In step 218, the BS 202 transmits a NetEntry MS State Change Acknowledgement (Ack) message to the AAA client 204 in response to the NetEntry MS State Change Response message.

In step 220, the AAA client 204 transmits to the BS 202 an AuthRelay_EAP_Transfer message for requesting authentication (e.g., password, and so forth) of the MS 200 whose authentication is confirmed.

In step 222, the BS 202 relays the received AuthRelay_EAP_Transfer message to the MS 200 in a format of PKMv2-RSP/EAP Transfer.

In step 224, the MS 200 transmits to the BS 202 a PKMv2-REQ/EAP Transfer message including a certificate.

In step 226, the BS 202 relays to the AAA client 204 an AuthRelay_EAP_Transfer message obtained by encapsulating the received PKMv2-REQ/EAP Transfer message.

In step 228, a home-AAA server 208 and the MS 200 perform EAP authentication. The EAP authentication may be EAP-TLS, EAP-TTLS, EAP-AKA, PEAP, and so forth.

In step 230, after the EAP authentication process, the AAA server 208 transmits a MS State Change Directive message to the BS 202.

In step 232, upon receiving the MS State Change Directive message, the BS 202 transmits to the MS 200 a PKMv2 EAP-Transfer message in order to report successful completion of EAP authentication. In step 234, the BS 202 transmits a NetEntry MS State Change Ack message to the AAA client 204 in response to the MS State Change Directive message.

Thereafter, the BS 202 evaluates an Authentication Key (AK) to be used and performs a PKMv2 3-way handshake (i.e., exchange of a SA-TEK-Challenge/Request/Response message) with the MS 200 in order to establish a preset Security Association (SA). That is, in step 236, the BS 202 transmits a SA-TEK-Challenge message to the MS 200. In step 238, upon receiving the SA-TEK-Challenge message, the MS 200 transmits a SA-TEK-Request message to the BS 202. In step 240, upon receiving the SA-TEK-Request message, the BS 202 transmits a SA-TEK-Response message to the MS 200.

In steps 242 and 244, the MS 200 exchanges a PKMv2 Key-Request/Reply message with the BS 202 to obtain a valid Traffic Encryption Key (TEK).

Thereafter, the authentication process of FIG. 2 ends.

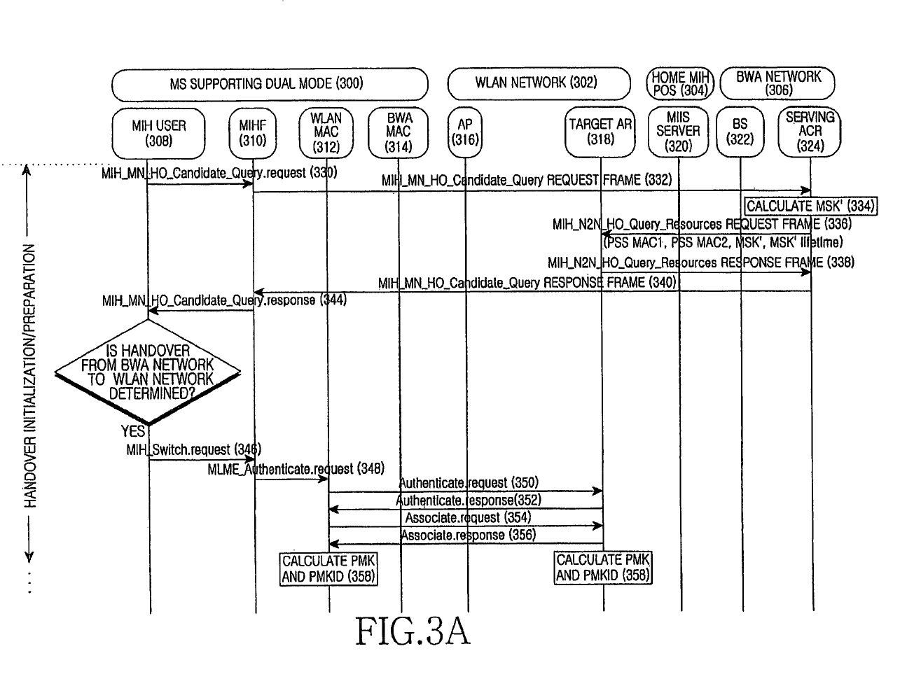

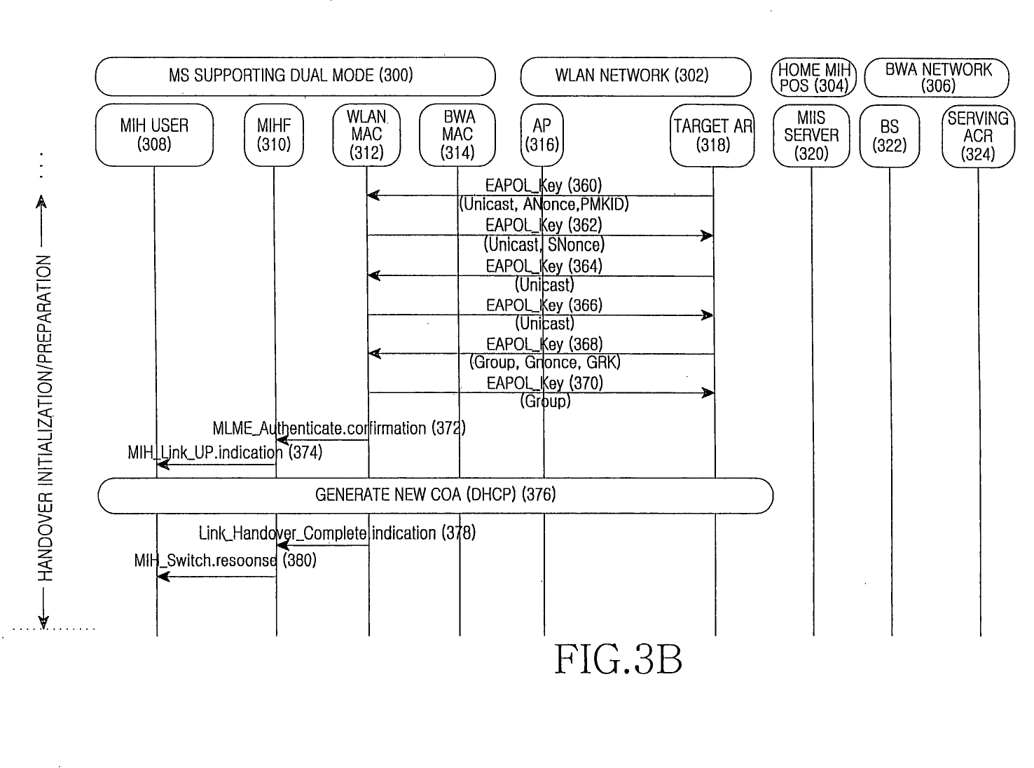

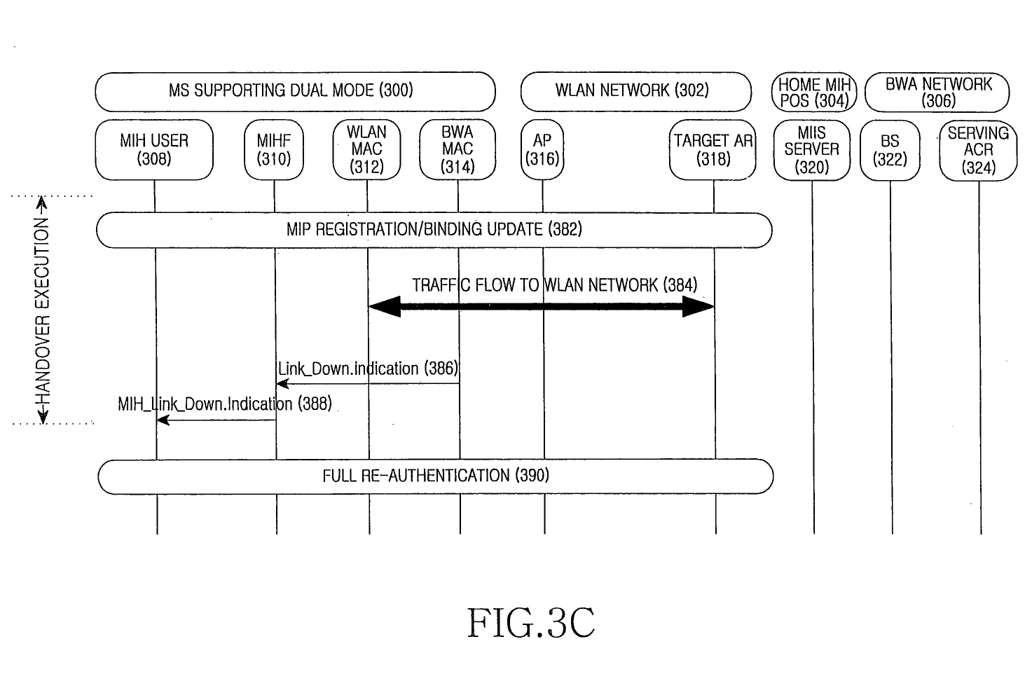

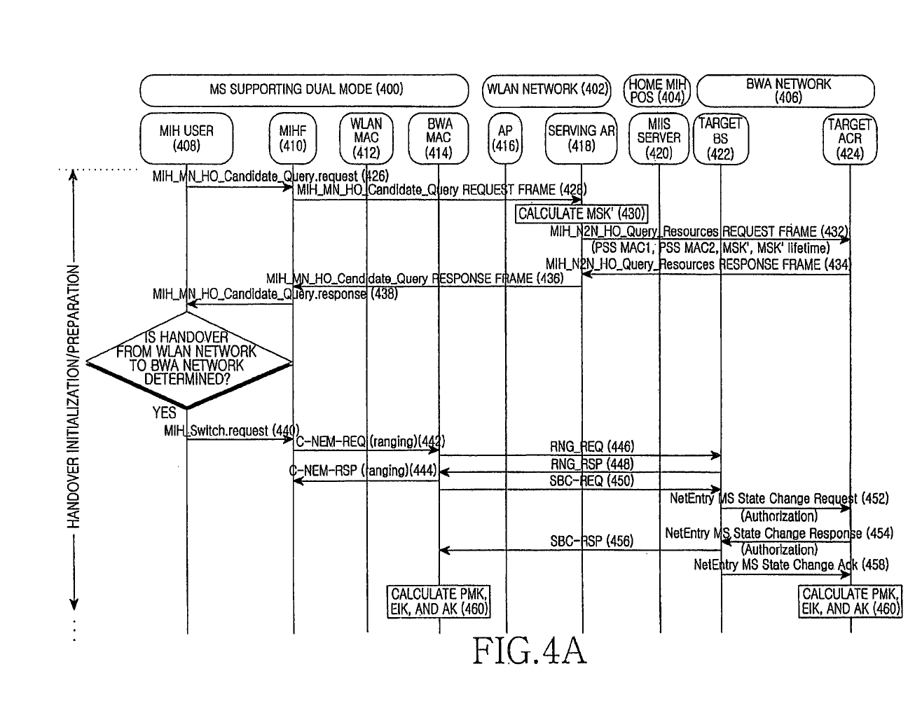

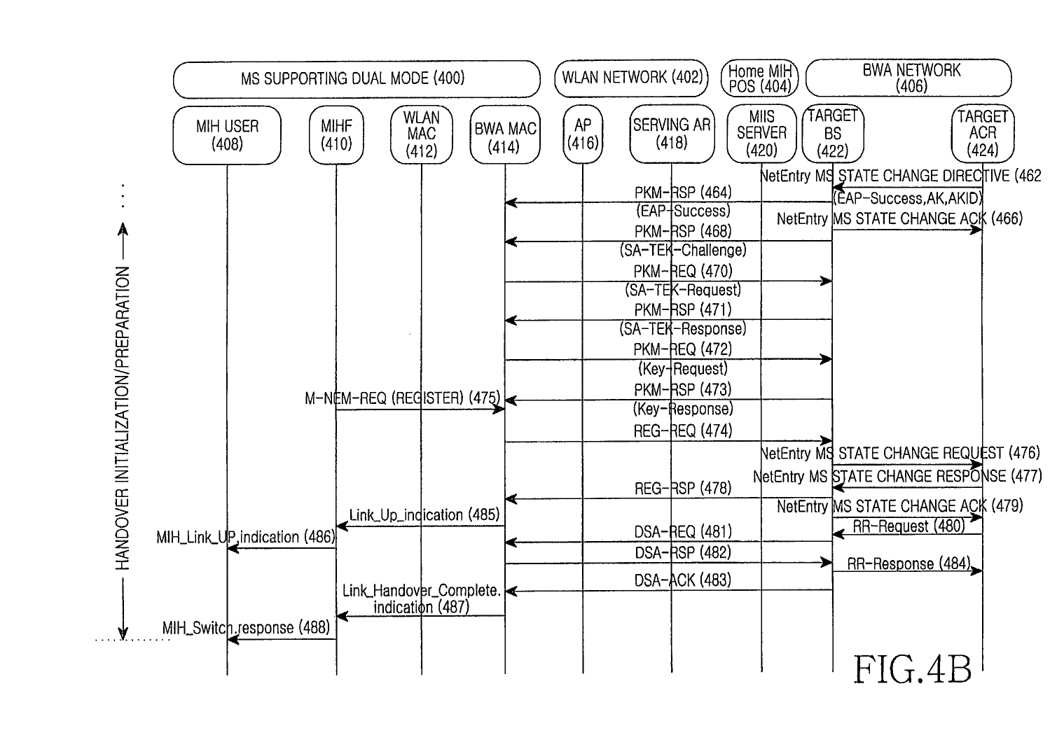

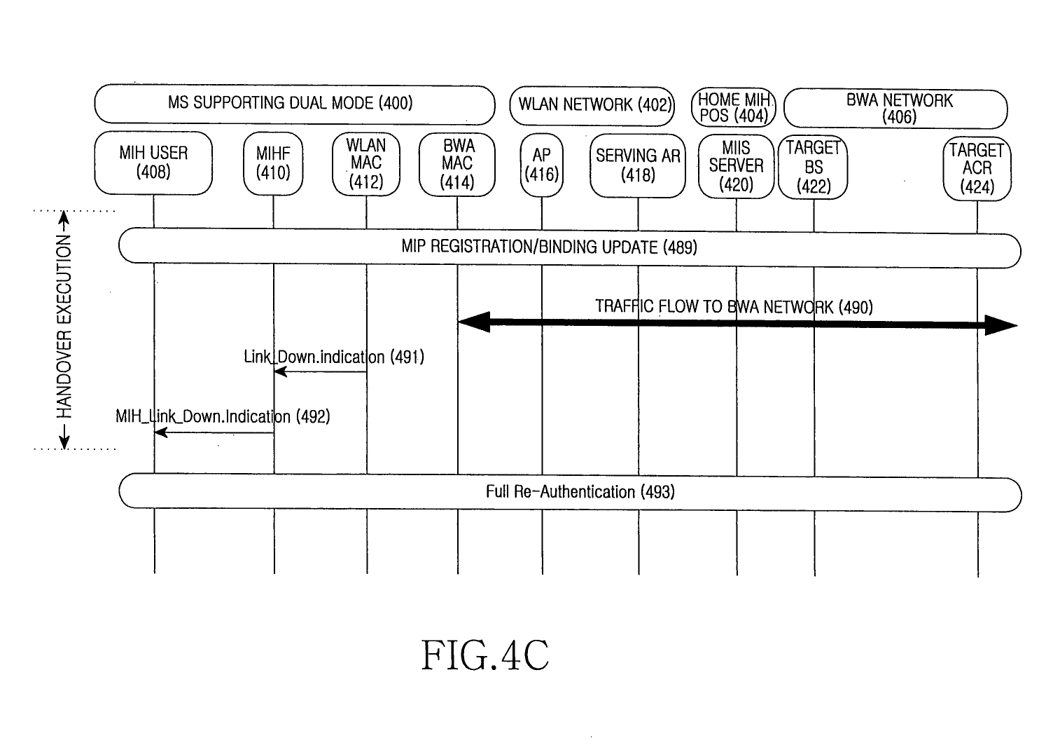

Now, an authentication process for performing a handover by a MS from a BWA network to a WLAN network (or from the WLAN network to the BWA network) will be described with reference to FIGS. 3 and 4. Herein, the MS supports a dual mode capable of accessing both the BWA network and the WLAN network. To support the handover from the BWA network to the WLAN network (or from the WLAN network to the BWA network), the MS internally supports a Media Independent Handover Function (MIHF) on the basis of the Institute of Electrical and Electronics Engineers (IEEE) 802.21 standard. The MIHF provides an asymmetric service and a symmetric service to upper layers and lower layers through a well-defined Service Access Point (SAP). The asymmetric service may be a Media Independent Event Service (MIES). The symmetric service may be a Media Independent Command Service (MICS). In addition, a Media Independent Information Service (MIIS) is provided for provision of information on homogeneous or heterogeneous networks within a certain geographical region.

FIGS. 3A to 3C illustrate a flow diagram illustrating an authentication process during a vertical handover according to a first embodiment of the present invention. In the first embodiment, a handover from a BWA network 306 to a WLAN network 302 is performed, and authentication is based on a Media Independent Handover (MIH).

Referring to FIGS. 3A to 3C, a MS 300 supporting a dual mode includes a MIH user 308, a MIHF 310, a WLAN Media Access Control (MAC) layer 312, and a BWA MAC layer 314. It is assumed that the MS 300 is initially connected to the BWA network 306.

The MIH user 308 is an upper layer of the MAC layers (of the WLAN network and the BWA network) and may be an application layer, a transport layer, and a network layer. The MIHF 310 provides a MIES, a MICS, and a MIIS between the MIH user 308 and the MAC layers 312 and 314. The WLAN MAC layer 312 supports a MAC protocol for accessing an Access Point (AP) 316 that provides a wireless service in a hotspot zone. The BWA MAC layer 314 supports a MAC protocol for accessing a BS 322 that constitutes the BWA network 306.

In a Mobile Initiated Handover (MIHO), downlink quality monitoring, handover decision, and handover target BS selection are performed by the MS 300. In step 330, the MIH user 308 transmits to the MIHF 310 a MIH command (i.e., MIH_MN_HO_Candidate_Query.request) for handover request.

In step 332, the MIHF 310 transmits to a serving Access Control Router (ACR) 324 a link command (i.e., MIH_MN_HO_Candidate_Query REQUEST FRAME) for handover request. The ACR 324 serves as an authenticator. According to embodiments, the MIHF 310 transmits the link command to the BS 322. In this case, instead of the serving ACR 324, the BS 322 can act as the authenticator.

When the handover is requested from the MIHF 310 of the MS 300, the serving ACR 324 calculates a derivative MSK (i.e., MSK′) for authentication in step 334 during a handover process by using an original MSK, MS MAC addresses in a serving network and a target network, and an authenticator MAC address. The original MSK may be generated through the full authentication in an initial BWA network entry (see FIG. 2). The serving network may be the BWA network. The target network may be the WLAN network. The MS MAC address may be a WLAN MAC address or a BWA MAC address. The authenticator MAC address may be an AP MAC address or a serving ACR MAC address. The MSK′ is generated according to Equation 1 below:

MSK′=HMAC-SHA512(MSK,“Derivative of MSK”|PSS_MAC1|PSS_MAC2|Serving Authenticator MAC|Target Authenticator MAC) [Eqn. 1]

In Equation 1, HMAC-SHA-512 denotes implementation of a Hash-based MAC (HMAC) message code by using an SHA-512 hash function, Serving Authenticator MAC denotes a serving network authenticator MAC, Target Authenticator MAC denotes a target network authenticator MAC, PSS_MAC1 denotes a serving network MS MAC, and PSS_MAC2 denotes a target network MS MAC.

According to embodiments, the MS 300 can also generate the derivative MSK (i.e., MSK′), and can receive the derivative MSK (i.e., MSK′) generated by the serving ACR 324. It is assumed herein that the MS 300 and the serving ACR 324 can exchange necessary information required to generate the derivative MSK (i.e., MSK′). Examples of the necessary information include PSS_MAC1, PSS_MAC2, Serving Authenticator MAC, and Target Authenticator MAC.

As described above, a MSK distributed from an authentication server is derived into a MSK′ by using MAC information of a MSK-independent network entity, and a domino effect can be reduced by the use of the MSK′. The domino effect is a phenomenon in which, when a root key of a key hierarchy for generating an authentication key or the like is exposed to a threat, other keys are also exposed to the threat as a result thereof. In addition, in an environment where a MSK used in a serving network is used without alteration in a target network, the MSK of the target network is also exposed to the threat when the MSK of the serving network is exposed to the threat.

In step 336, the serving ACR 324 transmits a request message (i.e., MIH_N2N_HO_Query_Resources REQUEST FRAME) to a target authenticator (i.e., a target AR 318). In this case, a MSK′, a MSK′ lifetime, a PSS_MAC1, and a PSS_MAC2 are encapsulated in the message. The PSS_MAC1 and the PSS_MAC2 are used for MS identification.

In step 338, the target AR 318 transmits a response message (i.e., MIH_N2N_HO_Query_Resources RESPONSE FRAME) to the serving ACR 324 in response to the request message (i.e., MIH_N2N_HO_Query_Resources REQUEST FRAME).

In step 340, the serving ACR 324 transmits to the MIHF 310 a handover response link event (i.e., MIH_MN_HO_Candidate_Query.RESPONSE FRAME) in response to the link command (i.e., MIH_MN_HO_Candidate_Query.REQUEST FRAME) for handover request.

In step 344, the MIHF 310 transmits to the MIH user 308 a handover response MIH event (i.e., MIH_MN_HO_Candidate_Query.RESPONSE) in response to the handover request.

In step 346, the MIH user 308 transmits to the MIHF 310 a switch request MIH command (i.e., MIH_Switch.request) when a handover from the BWA network 306 to the WLAN network 302 is determined.

In step 348, the MIHF 310 delivers an authentication request link command (MAC Layer Management Entity Authenticate.request (MLME_Authenticate.request)) to the WLAN MAC layer 312.

In step 350, the WLAN MAC layer 312 transmits an Authenticate.request message to the target AR 318. In step 352, the target AR 318 transmits an Authenticate.response message to the WLAN MAC layer 312.

In step 354, the WLAN MAC layer 312 transmits an Associate.response message to the target AR 318. In step 356, the target AR 318 transmits an Associate.response message to the WLAN MAC layer 312.

In step 358, the WLAN MAC layer 312 and the target AR 318 may evaluate a MSK′ cache and a MSK′ lifetime during a WLAN network entry process after successfully establishing a communication link. Thus, the target AR 318 can find a MSK′ which is effective for the MS 300. If the effective MSK′ is found, the target AR 318 calculates a Pairwise Master Key (PMK) and a PMK IDentity (PMKID) by using the MSK′ as a root key. In the same manner, the WLAN MAC layer 312 of the MS 300 can also calculate the PMK and the PMKID.

In steps 360 to 366, the WLAN MAC layer 312 and the target AR 318 verify a PMK used as a unicast message and perform a 4-way handshake (i.e., EAPOL-Key) for negotiation of encryption and authentication keys. The message conforms to a format defined in a WLAN standard. See the 4-way handshake (i.e., EAPOL-Key) described with reference to FIG. 1 above for further information on the WLAN standard.

In steps 368 to 370, the WLAN MAC layer 312 and the target AR 318 perform a 2-way handshake (i.e., EAPOL-Key) so as to encapsulate and deliver encryption keys and authentication keys.

In step 372, the WLAN MAC layer 312 transmits to the MIHF 310 a link event (i.e., MLME_Authenticate.confirmation) for confirming authentication.

In step 374, the MIHF 310 transmits to the MIH user 308 a MIH event (i.e., MIH_Link_UP.indication) to report that a Layer 2 (L2) link is established and usable.

In step 376, a Care-of-Address (CoA) is generated using a Dynamic Host Configuration Protocol (DHCP) between the target AR 318 and the MIH user 308 of the MS 300 attempting a handover to the WLAN network. The CoA is an Internet Protocol (IP) address used when a mobile node is located in an external network. When a counterpart node of the mobile node transmits a datagram to an original IP address of the mobile node, a home agent must deliver the datagram to the mobile node. In this case, the home agent delivers the datagram to an external agent with a tunneling scheme by using the CoA, and the external agent delivers the datagram to the mobile node by performing de-tunneling. In general, the CoA uses an IP address of the external agent.

In step 378, the WLAN MAC layer 312 transmits to the MIHF 310 a link event (i.e., Link_Handover_Complete.Indication) for reporting completion of handover.

In step 380, the MIHF 310 transmits to the MIH user 308 a switch response MIH event (i.e., MIH_Switch.response) in response to the switch request MIH event (i.e., MIH_Switch_request).

In step 382, a binding update process is performed between the target AR 318 and the MIH user 308 of the MS 300 attempting a handover to the WLAN network in order to register a Mobile IP (MIP) and to provide transparency for an upper layer protocol.

In step 384, a traffic flow is generated between the WLAN MAC layer 312 and the target AR 318. Accordingly, traffic received from the BWA network 306 can be received by the MS 300 from the target AR 318.

In step 386, the BWA MAC layer 314 disconnects the L2 link and transmits to the MIHF 310 a link event (i.e., Link_Down.Indication) which indicates that the link is unusable.

In step 388, the MIHF 310 disconnects the L2 link and transmits to the MIH user 308 a MIH event (i.e., MIH_Link_Down.indication) which reports that the link is unusable. Accordingly, the MS 300 performs a handover from the BWA network 306 to the WLAN network 302.

Thereafter, full re-authentication starts after the handover is completed between the MS 300 and the target AR 318. As a result, a domino effect and authentication parameter disparity can be reduced by distributing the MSK while not affecting a handover performance.

Thereafter, the authentication process of FIGS. 3A to 3C ends.

FIGS. 4A to 4C illustrate a flow diagram illustrating an authentication process during a vertical handover according to a second embodiment of the present invention. In the second embodiment, a handover from a WLAN network 402 to a BWA network 406 is performed, and authentication is based on a MIH.

Referring to FIGS. 4A to 4C, a MS 400 supporting a dual mode includes a MIH user 408, a MIHF 410, a WLAN MAC layer 412, and a BWA MAC layer 414. Functions of the MIH user 408, the MIHF 410, the WLAN MAC layer 412, and the BWA MAC layer 414 are similar to those described in FIGS. 3A to 3C above, and thus detailed descriptions thereof will be omitted.

In a MIHO, downlink quality monitoring, handover decision, and handover target BS selection are performed by the MS 400. In step 426, the MIH user 408 transmits to the MIHF 410 a MIH command (i.e., MIH_MN_HO_Candidate_Query.request) for handover request.

In step 428, the MIHF 410 transmits to a serving AR 418 a link command (i.e., MIH_MN_HO_Candidate_Query REQUEST FRAME) for handover request. According to embodiments, the MIHF 410 may transmit the link command for handover request to an AP 416. In this case, instead of the serving AR 418, the AP 416 can act as an authenticator.

When the handover is requested from the MIHF 410 of the MS 400, the serving AR 418 calculates a derivative MSK (i.e., MSK′) for authentication in step 430 during a handover process by using an original Master Session Key (MSK), MS MAC addresses in a serving network and a target network, and an authenticator MAC address. The original MSK may be generated through the full authentication in an initial WLAN network entry (see FIG. 1). The serving network may be the BWA network. The target network may be the WLAN network. The MS MAC address may be a WLAN MAC address or a BWA MAC address. The authenticator MAC address may be an AP MAC address or a serving ACR MAC address. The MSK′ is generated according to Equation 1 above.

According to embodiments, the MS 400 can also generate the derivative MSK (i.e., MSK′), and can receive the derivative MSK (i.e., MSK′) generated by the serving AR 418. It is assumed herein that the MS 400 and the serving AR 418 can exchange necessary information required to generate the derivative MSK (i.e., MSK′). Examples of the necessary information include PSS_MAC1, PSS_MAC2, Serving Authenticator MAC, and Target Authenticator MAC.

In step 432, the serving AR 418 transmits a request message (i.e., MIH_N2N_HO_Query_Resources REQUEST FRAME) to a target authenticator, i.e., a target ACR 424, in order to request a handover resource. In this case, a MSK′, a MSK′ lifetime, a PSS_MAC1, and a PSS_MAC2 are encapsulated in the message. The PSS_MAC1 and the PSS_MAC2 are used for MS identification.

In step 434, the target ACR 424 transmits a response message (i.e., MIH_N2N_HO_Query_Resources RESPONSE FRAME) to the serving AR 418 in response to the request message (i.e., MIH_N2N_HO_Query_Resources REQUEST FRAME).

In step 436, the serving AR 418 transmits to the MIHF 410 a handover response link command (i.e., MIH_MN_HO_Candidate_Query.RESPONSE FRAME) in response to a link command (i.e., MIH_MN_HO_Candidate_Query.REQUEST FRAME) for handover request.

In step 438, the MIHF 410 transmits to the MIH user 408 a MIH command (i.e., MIH_MN_HO_Candidate_Query.RESPONSE) for handover request.

In step 440, the MIH user 408 transmits to the MIHF 410 a switch request MIH command (i.e., MIH_Switch.request) when a handover from the WLAN network 402 to the BWA network 406 is determined.

In step 442, the MIHF 410 delivers a ranging request link command (i.e., C-NEM_REQ(Ranging)) to the BWA MAC layer 414. In step 444, the BWA MAC layer 414 delivers a ranging response link event (i.e., C-NEM_RSP(Ranging)) to the MIHF 410.

In step 446, the BWA MAC layer 414 transmits a ranging request message (i.e., RNG_REQ) to a target BS 422. In step 448, the target BS 422 transmits a ranging response message (i.e., RNG_RSP) to the BWA MAC layer 414.

In step 450, the BWA MAC layer 414 transmits to the target BS 422 a SBC-REQ message. The SBC-REQ message is used to negotiate an authentication policy and a message authentication code mode.

In step 452, in order to report information on the MS 400 which attempts network entry, the target BS 422 transmits a NetEntry MS State Change Request message to the target ACR 424.

In step 454, the target ACR 424 transmits a NetEntry MS State Change Response message to the target BS 422.

In step 456, the target BS 422 transmits a SBC-RSP message to the BWA MAC layer 414.

In step 458, the target BS 422 transmits to the target ACR 424 a NetEntry MS State Change Ack message in response to the NetEntry MS State Change Response message. According to embodiments, the NetEntry MS State Change Ack message may be transmitted prior to the SBC-RSP message. In addition, a MSK′ of the MS 400 and a MSK′ of the target ACR 424 are generated and preserved by the MS 400 and the target ACR 424. Thus, the MS 400 and the target ACR 424 determine whether their derivative MSKs are matched from each other.

In step 460, a MSK′ cache and a MSK′ lifetime may be evaluated in the BWA network 406 after successfully establishing a communication link. Thus, the target ACR 424 can find a MSK′ which is effective for the MS 400. If the effective MSK′ is found, the target ACR 424 calculates a PMK, an EAP Integrity Key (EIK), and an Authentication Key (AK). In the same manner, the BWA MAC layer 414 of the MS 400 can calculate the PMK, the EIK, and the AK.

In step 462, the target ACR 424 transmits to the target BS 422 a NetEntry MS State Change Directive message in order to report successful completion of EAP authentication. The NetEntry MS State Change Directive message includes an EAP success message and an EAP payload Time, Length, and Value (TLV) having authentication completion parameters. In fact, in the full authentication, the NetEntry MS State Change Directive message is delivered after successful multi-round access authentication. That is, in case of FIG. 2, the MS 400 and the target ACR 424 transmit the NetEntry MS State Change Directive message throughout steps 220 to 228. However, these steps 220 to 228 are skipped in the present invention by using the derivative MSK′, thereby decreasing a handover delay.

In step 464, the target BS 422 transmits to the MS 400 a PKM-RSP message for reporting successful completion of EAP authentication. In step 466, the target BS 422 transmits to the target ACR 424 a NetEntry MS State Change Ack message in response to the NetEntry MS State Change Directive message.

Thereafter, the target BS 422 evaluates an Authentication Key (AK) to be used and performs a PKMv2 3-way handshake (i.e., exchange of a SA-TEK-Challenge/Request/Response message) with the MS 400 in order to establish a preset Security Association (SA). That is, the target BS 422 transmits a SA-TEK-Challenge message to the MS 400 in step 468. Upon receiving the SA-TEK-Challenge message, the MS 400 transmits a SA-TEK-Request message to the target BS 422 in step 470. Upon receiving the SA-TEK-Request message, the target BS 422 transmits a SA-TEK-Response message to the MS 400 in step 471.

In steps 472 and 473, the MS 400 exchanges a PKMv2 Key-Request/Reply message with the target BS 422 to obtain a valid Traffic Encryption Key (TEK).

In step 475, the MIHF 410 transmits to the BWA MAC layer 414 a link command (i.e., M-NEM-REQ(register)) for requesting registration.

In step 474, the BWA MAC layer 414 transmits to the target BS 422 a REG-REQ message.

In step 476, in order to report information on the MS 400 which attempts network entry, the target BS 422 transmits to the target ACR 424 a NetEntry MS State Change Request message. In step 477, the target ACR 424 transmits to the target BS 422 a NetEntry MS State Change Response message.

In step 478, the target BS 422 transmits to the BWA MAC layer 414 a REG-RSP message.

In step 479, the target BS 422 transmits to the target ACR 424 a NetEntry MS State Change Ack message in response to the NetEntry MS State Change Response message. According to embodiments, the NetEntry MS State Change Ack message may be transmitted prior to the REG-RSP message.

In step 485, the BWA MAC layer 414 transmits to the MIHF 410 a link event (i.e., MIH_Link_UP.indication) to report that an L2 link is established and usable.

In step 486, the MIHF 410 transmits to the MIH user 408 a MIH event (i.e., MIH_Link_UP.indication) to report that the L2 link is established and usable.

In step 480, the target ACR 424 transmits to the target BS 422 a Radio Resource (RR)-Request message for requesting a radio resource.

In step 481, the target BS 422 transmits to the BWA MAC layer 414 a Dynamic Service Addition REQuest (DSA-REQ) message for generating a new service flow.

In step 482, the BWA MAC layer 414 transmits to the target BS 422 a DSA-RSP message in response to the DSA-REQ message.

In step 484, the target BS 422 transmits to the target ACR 424 an RR-Response message in response to the RR-Request message.

In step 483, the target BS 422 transmits to the BWA MAC layer 414 a DSA-ACK message in response to the DSA-RSP message.

In step 487, the BWA MAC layer 414 transmits to the MIHF 410 a link event (i.e., Link_Handover_Complete.Indication) for reporting handover completion.

In step 488, the MIHF 410 transmits to the MIH user 408 a switch response MIH event (i.e., MIH_Switch.response) in response to the switch request MIH event (i.e., MIH_Switch_request).

In step 489, a home address and a temporary address are binding-updated between the target ACR 424 and the MS 400 attempting a handover to the BWA network 406 in order to register a Mobile IP (MIP) and to provide transparency for an upper layer protocol.

In step 490, a traffic flow is generated between the BWA MAC layer 414 and the target ACR 424. That is, traffic received from the WLAN network 402 is received by the MS 400 from the target ACR 424.

In step 491, the WLAN MAC layer 412 disconnects the L2 link and transmits to the MIHF 410 a link event (i.e., Link_Down.Indication) which indicates that the link is unusable.

In step 492, the MIHF 410 disconnects the L2 link and transmits to the MIH user 408 a MIH event (i.e., MIH_Link_Down.indication) which indicates that the link is unusable. Accordingly, the MS 400 performs a handover from the WLAN network 402 to the BWA network 406.

In step 493, full re-authentication starts after the handover is completed between the MS 400 and the target ACR 424. As a result, a domino effect and authentication parameter disparity can be reduced by distributing the MSK while not affecting a handover performance.

Thereafter, the authentication process of FIGS. 4A to 4C ends.

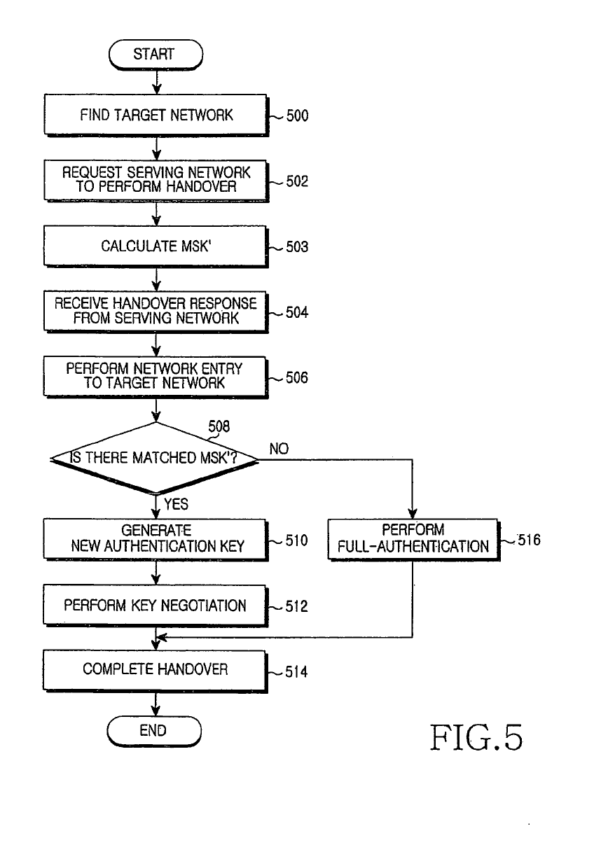

FIG. 5 is a flowchart illustrating an operation of a MS for performing fast authentication during a vertical handover according to an embodiment of the present invention.

Referring to FIG. 5, the MS performs scanning to find a target network in step 500.

In step 502, the MS requests a serving network to perform a handover. In the handover request, information on the target network found through scanning is also included.

In step 503, the MS generates a derivative MSK′ for authentication during the handover. For example, the MS generates the derivative MSK′ (see Equation 1 above) by using its serving network information (i.e., serving network's authenticator MAC information and MS MAC information) and target network information (i.e., target network's authenticator MAC information and MS MAC information). According to embodiments, the MS can receive the derivate MSK′ from a serving authenticator.

In step 504, the MS receives a handover response message from the serving network.

In step 506, the MS performs network entry to the target network. Herein, the MS can compare its own MSK′ with a derivative MSK′ of the target network in the network entry process.

In step 508, the MS determines whether there exists a MSK′ matched to the MSK′ generated by a corresponding target authenticator. If the matched MSK′ exists, proceeding to step 510, the MS generates a new authentication key. For example, in an environment where the MS performs a handover from a BWA network to a WLAN network, the MS generates a PMK and a PMKID by using the new authentication key. In an environment where the MS performs a handover from the WLAN network to the BWA network, the MS generates a PMK, an EIK, and an AK.

Otherwise, if there is no matched MSK′ in step 508, proceeding to step 516, the MS performs a full-authentication process. For example, a fast authentication process may be performed from the BWA network to the WLAN network as shown in FIG. 2, or a fast authentication process may be performed from the WLAN network to the BWA network as shown in FIG. 1.

In step 512, the MS performs key negotiation with the target network in order to match the generated key.

In step 514, the MS completes the handover.

Thereafter, the procedure of FIG. 5 ends.

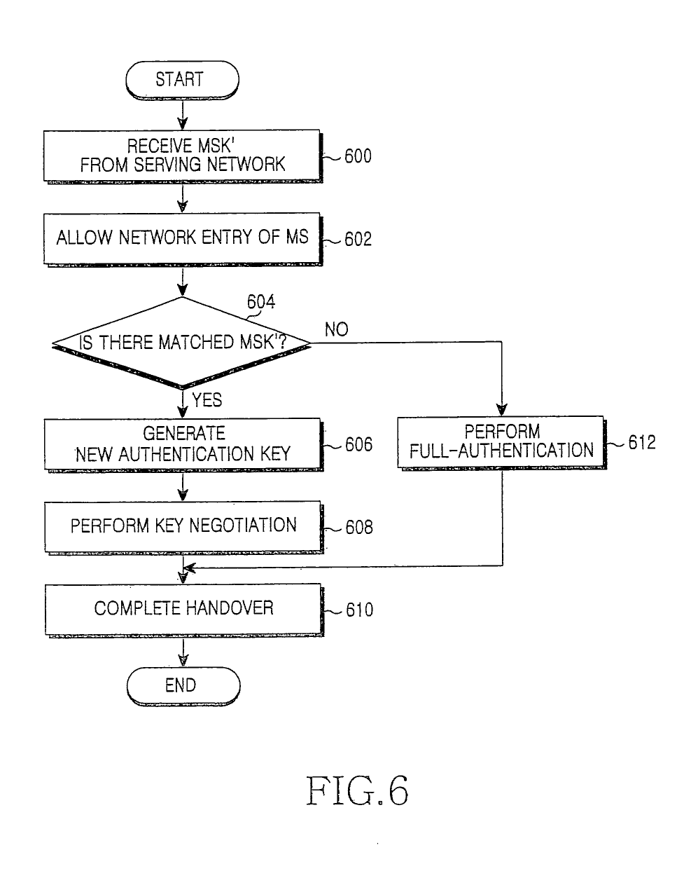

FIG. 6 is a flowchart illustrating an operation of a target authenticator for performing authentication during a vertical handover according to an embodiment of the present invention. The target authenticator may be a BS or an AP.

Referring to FIG. 6, the target authenticator receives a derivative MSK (i.e., MSK′) from a serving network through a backbone in step 600.

In step 602, the target authenticator allows network entry according to a predetermined process. While the network entry process is performed with a MS, the target authenticator can compare its own MSK′ with a derivative MSK′ of the MS.

In step 604, the MS determines whether there exists a MSK′ matched to the MSK′ generated by the MS of a corresponding serving network. If the matched MSK′ exists, proceeding to step 606, the MS generates a new authentication key. For example, in an environment where the MS performs a handover from a BWA network to a WLAN network, the MS generates a PMK and a PMKID by using the new authentication key. In an environment where the MS performs a handover from the WLAN network to the BWA network, the MS generates a PMK, an EIK, and an AK.

Otherwise, if there is no matched MSK′ in step 604, proceeding to step 612, the MS performs a full-authentication process. For example, a fast authentication process may be performed from the BWA network to the WLAN network as shown in FIG. 2, or a fast authentication process may be performed from the WLAN network to the BWA network as shown in FIG. 1.

In step 608, the MS performs key negotiation with the target network in order to match the generated key.

In step 610, the MS completes the handover.

Thereafter, the procedure of FIG. 6 ends.

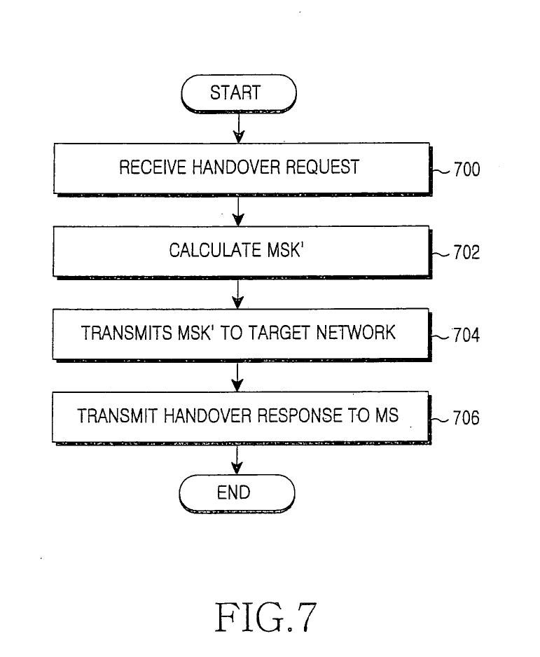

FIG. 7 is a flowchart illustrating an operation of a serving authenticator for performing authentication during a vertical handover according to an embodiment of the present invention. The serving authenticator may be a BS or an AP.

Referring to FIG. 7, the serving authenticator receives a handover request from a MS in step 700.

In step 702, the serving authenticator generates a derivative MSK′ for authentication during the handover. For example, the serving authenticator generates the derivative MSK′ (see Equation 1 above) by using its serving network information (i.e., serving network's authenticator MAC information and MS MAC information) and target network information (i.e., target network's authenticator MAC information and MS MAC information).

In step 704, the serving authenticator transmits to the target network the generated MSK′ together with MS information.

In step 706, the serving authenticator transmits a handover response by using the MS information.

Thereafter, the procedure of FIG. 7 ends.

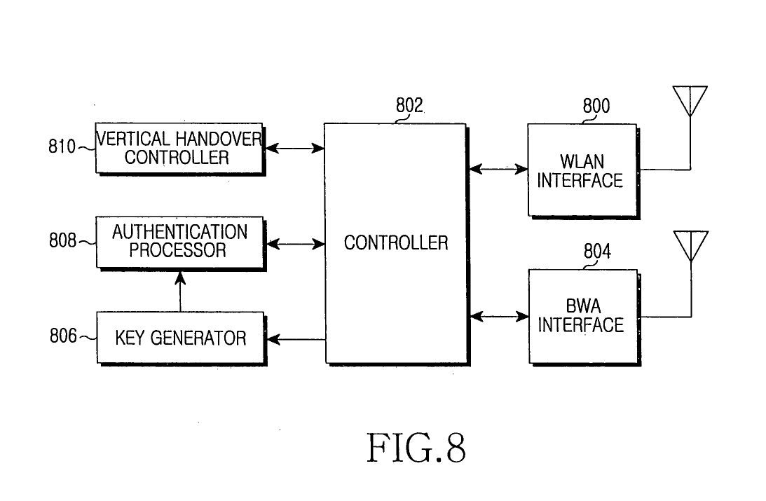

FIG. 8 is a block diagram illustrating a MS apparatus for performing fast authentication during a vertical handover according to an embodiment of the present invention.

Referring to FIG. 8, the MS includes a WLAN interface 800, a controller 802, a BWA interface 804, a key generator 806, an authentication processor 808, and a vertical handover controller 810.

The controller 802 provides overall control to the MS which supports a dual mode (i.e., a WLAN mode and a BWA mode). For example, the controller 802 provides processing and control for an Internet service (e.g., authentication, security, and so forth.) through a WLAN network. In addition, the controller 802 also provides processing and control for a multimedia service and an Internet service. In addition to typical functions, the controller 802 of the present invention provides processing and control for a re-authentication process performed between a WLAN system and a BWA system. For example, the controller 802 receives information used to generate a derivative MSK in order to generate a key after a vertical handover request and then provides the received information to the key generator 806. Descriptions on typical processing and control of the controller 802 will be omitted in the following descriptions.

The key generator 806 receives information from the controller 802 and generates a derivative MSK. The derivative MSK is generated from an authenticator MAC address, a MS MAC address, an original MSK in the serving network and is generated from an authenticator MAC address and a MS MAC address in the target network.

The authentication processor 808 generates authentication control messages under the control of the controller 802 and outputs the generated messages to the WLAN interface 800 or the BWA interface 804. Further, the authentication processor 808 receives the authentication control messages from the WLAN interface 800 or the BWA interface 804, analyzes the received messages, and provides the analyzed message to the controller 802. For example, the authentication processor 808 performs key negotiation with a target authenticator by using the derivative MSK. More specifically, the authentication processor 808 performs the key negotiation with the target authenticator by using the derivative MSK, performs network entry with the target authenticator, determines whether the matched derivative MSK exists, generates a new authentication key by using the derivative MSK, and exchanges the new authentication key with the target authenticator.

The vertical handover controller 810 controls a handover between heterogeneous networks on the basis of a MIH (e.g., a MIH event, a MIH command, a link event, a link command, and so forth).

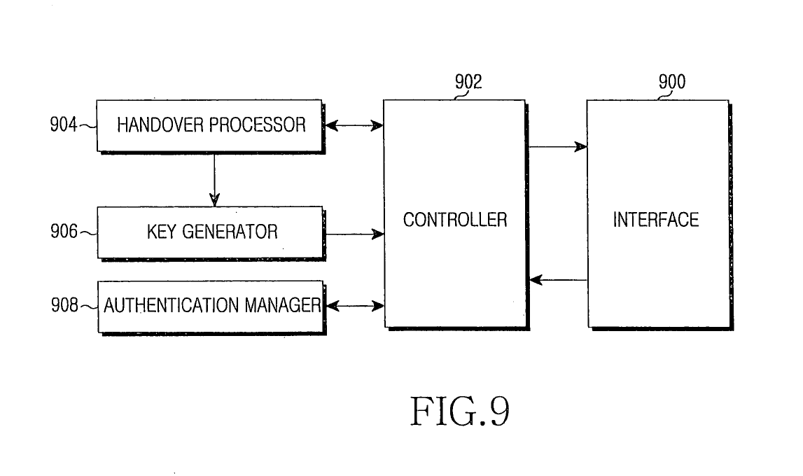

FIG. 9 is a block diagram illustrating a serving authentication apparatus for performing authentication during a vertical handover according to an exemplary embodiment of the present invention.

Referring to FIG. 9, the authentication apparatus includes an interface 900, a controller 902, a handover processor 904, a key generator 906, and an authentication manager 908.

The interface 900 provides an interface for the connection with a WLAN MS or a BWA MS. Therefore, the interface 900 may transmit an authentication control message to a corresponding MS or may receive the authentication control message from the corresponding MS and transmit the received message to the authentication manager 908 under the control of the controller 902.

The controller 902 receives from a serving authenticator a derivative MSK for key generation.

The handover processor 904 controls a handover between heterogeneous networks on the basis of a MIH (e.g., a MIH event, a MIH command, a link event, a link command, and so forth).

The key generator 906 requests a handover and then generates a derivative MSK. The derivative MSK is generated from an authenticator MAC address, a MS MAC address, and an original MSK in the serving network and is generated from an authenticator MAC address and a MS MAC address in the target network.

The authentication manager 908 performs key negotiation with a MS by using the derivative MSK. That is, the authentication manager 908 performs key negotiation with a target authenticator by using the derivative MSK, allows network entry of the MS, determines existence of the matched derivative MSK, generates a new authentication key by using the derivative MSK, and exchanges the new authentication key with the MS. Further, the authentication manager 908 transmits the derivative MSK to the target authenticator.

According to the present invention, by using a derivative MSK during a vertical handover, a key negotiation process can start by skipping an access authentication process. Therefore, there is an advantage in that a fast authentication process can be achieved.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of performing fast authentication for a vertical handover, the method comprising:
requesting a handover from a serving network to a target network and generating a derivative Master Session Key (MSK) for key generation; and
transmitting the derivative Master Session Key to the target network.

2. The method of claim 1, further comprising responding to the handover request.

3. The method of claim 2, wherein, in the responding to the handover request, at least one of a Media Access Control (MAC) information of a serving mobile station (MS), a MAC information of a target mobile station, an original Master Session Key, and a lifetime information of the derivative Master Session Key is transmitted to the target network.

4. The method of claim 1, further comprising performing a key negotiation using the derivative Master Session Key.

5. The method of claim 4, wherein the derivative Master Session Key is generated from an authenticator MAC address, a mobile station MAC address, and an original Master Session Key in the serving network and is generated from an authenticator MAC address and a mobile station MAC address in the target network, and the derivate Master Session Key is expressed as:
MSK′=HMAC-SHA512(MSK,“Derivative of MSK”|PSS_MAC1|PSS_MAC2|Serving Authenticator MAC|Target Authenticator MAC),
where HMAC-SHA-512 denotes implementation of a Hash-based MAC (HMAC) message code by using an SHA-512 hash function, Serving Authenticator MAC denotes a serving network authenticator Media Access Control, Target Authenticator MAC denotes a target network authenticator Media Access Control, PSS_MAC1 denotes a serving network mobile station Media Access Control, and PSS_MAC2 denotes a target network mobile station Media Access Control.

6. The method of claim 4, further comprising, after the performing of the key negotiation, generating a Care-of-Address (CoA).

7. The method of claim 6, further comprising, after the generating of the Care-of-Address, registering a mobile Internet Protocol (IP) and performing a binding update.

8. The method of claim 1, wherein, after completing the handover, performing a full re-authentication when authentication is performed.

9. The method of claim 1, wherein the vertical handover is performed based on a Media Independent Handover (MIH).

10. A mobile communication system performing fast authentication for a vertical handover, the system comprising:
a serving mobile station (MS) for requesting a handover from a serving network to a target network; and
a serving authenticator for generating a derivative Master Session Key (MSK) for key generation in the serving network and for transmitting the generated Master Session Key to the target network.

11. The system of claim 10, wherein the serving authenticator responds to the handover request of the serving mobile station.

12. The system of claim 11, wherein, when responding to the handover request, at least one of a Media Access Control (MAC) information of the serving mobile station, a MAC information of a target mobile station, an original Master Session Key, and a lifetime information of the derivative Master Session Key is transmitted to the target network.

13. The system of claim 10, wherein a key negotiation is performed by using the derivative Master Session Key.

14. The system of claim 13, wherein the derivative Master Session Key is generated from an authenticator MAC address, a mobile station MAC address, and an original Master Session Key in the serving network and is generated from an authenticator MAC address and a mobile station MAC address in the target network, and the derivate Master Session Key is expressed as:
MSK′=HMAC-SHA512(MSK,“Derivative of MSK”|PSS_MAC1|PSS_MAC2|Serving Authenticator MAC|Target Authenticator MAC),
where HMAC-SHA-512 denotes implementation of a HMAC message code by using an SHA-512 hash function, Serving Authenticator MAC denotes a serving network authenticator Media Access Control, Target Authenticator MAC denotes a target network authenticator Media Access Control, PSS_MAC1 denotes a serving network mobile station Media Access Control, and PSS_MAC2 denotes a target network mobile station Media Access Control.

15. The system of claim 13, wherein, after the key negotiation is performed, a Care-of-Address (CoA) is generated.

16. The system of claim 15, wherein, after the Care-of-Address is generated, a mobile Internet Protocol (IP) address is registered between the mobile station and the target authenticator and a binding update is performed.

17. The system of claim 10, wherein, after the handover is completed, a full re-authentication is performed when authentication is performed between the mobile station and the target authenticator.

18. The system of claim 10, wherein the vertical handover is performed based on a Media Independent Handover (MIH).

19. A method of operating a mobile station (MS) performing fast authentication for a vertical handover, the method comprising:
after requesting a handover to a target network, receiving an information used to generate a first derivative Master Session Key (MSK) for a key generation;
generating the derivative Master Session Key; and
performing a key negotiation with the target network by using the derivative Master Session Key.

20. The system of claim 19, wherein the derivative MSK is generated from an authenticator Media Access Control (MAC) address, a MS MAC address, and an original MSK in the serving network and is generated from an authenticator MAC address and a MS MAC address in the target network, and the derivate MSK is expressed as:
MSK′=HMAC-SHA512(MSK,“Derivative of MSK”|PSS_MAC1|PSS_MAC2|Serving Authenticator MAC|Target Authenticator MAC),
where HMAC-SHA-512 denotes implementation of a HMAC message code by using an SHA-512 hash function, Serving Authenticator MAC denotes a serving network authenticator MAC, Target Authenticator MAC denotes a target network authenticator MAC, PSS_MAC1 denotes a serving network MS MAC, and PSS_MAC2 denotes a target network MS MAC.

21. The method of claim 19, wherein the performing of the key negotiation with the target network by using the derivative MSK comprises:
performing network entry with the target entry;
determining whether the first derivative MSK is matched to a second MSK of the target network;
generating a new authentication key by using the derivative MSK;
exchanging the new authentication key with the target network; and
receiving the second MSK by the target network from a serving network.

22. The method of claim 19, further comprising, after the performing of the network entry key negotiation, completing the handover.

23. A method of operating a target authenticator performing fast authentication for a vertical handover; the method comprising:
receiving a first derivative Master Session Key (MSK) for key generation from a serving network; and
performing key negotiation by using the derivative MSK.

24. The method of claim 23, wherein the performing of the key negotiation by using the derivative MSK comprises:
allowing network entry of a mobile station (MS);
determining whether the first derivative MSK is matched to a second derivative MSK of the MS;
generating a new authentication key by using the first derivative MSK; and
exchanging the new authentication key with the MS.

25. The method of claim 23, further comprising, after the performing of the key negotiation, completing the handover.

26. A method of operating a serving authenticator performing fast authentication for a vertical handover, the method comprising:
after receiving a handover request from a mobile station (MS), generating a derivative Master Session Key (MSK); and
transmitting the derivative Master Session Key to a target network.

27. The method of claim 26, further comprising responding to the handover request.

28. The method of claim 26, wherein the derivative Master Session Key is generated from an authenticator Media Access Control (MAC) address, a mobile station MAC address, and an original Master Session Key in the serving network and is generated from an authenticator MAC address and a mobile station MAC address in the target network, and the derivate Master Session Key is expressed as:
MSK′=HMAC-SHA512(MSK,“Derivative of MSK”|PSS_MAC1|PSS_MAC2|Serving Authenticator MAC|Target Authenticator MAC),
where HMAC-SHA-512 denotes implementation of a HMAC message code by using an SHA-512 hash function, Serving Authenticator MAC denotes a serving network authenticator Media Access Control, Target Authenticator MAC denotes a target network authenticator Media Access Control, PSS_MAC1 denotes a serving network mobile station Media Access Control, and PSS_MAC2 denotes a target network mobile station Media Access Control.

29. A mobile station (MS) apparatus performing fast authentication for a vertical handover, the apparatus comprising:
a controller for receiving an information used to generate a first derivative Master Session Key (MSK) for a key generation after requesting a handover to a target network;
a key generator for generating the derivative Master Session Key; and
an authentication processor for performing a key negotiation with the target network by using the derivative Master Session Key.

30. The apparatus of claim 29, wherein the derivative Master Session Key is generated from an authenticator Media Access Control (MAC) address, a mobile station MAC address, and an original Master Session Key in the serving network and is generated from an authenticator MAC address and a mobile station MAC address in the target network, and the derivate Master Session Key is expressed as:
MSK′=HMAC-SHA512(MSK,“Derivative of MSK”|PSS_MAC1|PSS_MAC2|Serving Authenticator MAC|Target Authenticator MAC),
where HMAC-SHA-512 denotes implementation of a HMAC message code by using an SHA-512 hash function, Serving Authenticator MAC denotes a serving network authenticator Media Access Control, Target Authenticator MAC denotes a target network authenticator Media Access Control, PSS_MAC1 denotes a serving network mobile station Media Access Control, and PSS_MAC2 denotes a target network mobile station Media Access Control.

31. The apparatus of claim 29, wherein the authentication processor performs a network entry with the target entry, determines whether the first derivative Master Session Key is matched to a second Master Session Key of the target network, generates a new authentication key by using the derivative Master Session Key, exchanges the new authentication key with the target network, and receives the second Master Session Key by the target network from a serving network.

32. The apparatus of claim 29, further comprising a vertical handover controller for completing the handover after the key negotiation is performed.

33. A target authentication apparatus performing fast authentication for a vertical handover, the apparatus comprising:
a controller for receiving a first derivative Master Session Key (MSK) for key generation from a serving network; and
an authentication manager for performing key negotiation by using the derivative Master Session Key.

34. The apparatus of claim 33, wherein the authentication manager performs a key negotiation with a target authenticator by using the derivative Master Session Key, allows a network entry of a mobile station (MS), determines whether the first derivative Master Session Key is matched to a second derivative Master Session Key of the mobile station, generates a new authentication key by using the first derivative Master Session Key, and exchanges the new authentication key with the mobile station.

35. The apparatus of claim 33, further comprising a handover processor for completing the handover after the key negotiation is performed.

36. A serving authentication apparatus performing fast authentication for a vertical handover, the apparatus comprising:
a handover processor for receiving a handover request from a mobile station (MS);
a key generator for generating a derivative Master Session Key (MSK) after the handover request; and
an authentication processor for transmitting the derivative Master Session Key to a network.

37. The apparatus of claim 36, wherein the handover processor responds to the handover request.

38. The apparatus of claim 36, wherein the derivative MSK is generated from an authenticator Media Access Control (MAC) address, a mobile station MAC address, and an original Master Session Key in the serving network and is generated from an authenticator MAC address and a mobile station MAC address in the target network, and the derivate Master Session Key is expressed as:
MSK′=HMAC-SHA512(MSK,“Derivative of MSK”|PSS_MAC1|PSS_MAC2|Serving Authenticator MAC|Target Authenticator MAC),
where HMAC-SHA-512 denotes implementation of a HMAC message code by using an SHA-512 hash function, Serving Authenticator MAC denotes a serving network authenticator Media Access Control, Target Authenticator MAC denotes a target network authenticator Media Access Control, PSS_MAC1 denotes a serving network mobile station Media Access Control, and PSS_MAC2 denotes a target network mobile station Media Access Control.
